(19) United States
(12) Patent Application Publication
(10) Pub. No.: US 2006/0293428 A1
(43) Pub. Date: Dec. 28, 2006

(54) Two-step process for rapid structure repair

(76) Inventors: Rina Singh, Westerville, OH (US); Robert B. Fechter, Worthington, OH (US)

Correspondence Address: David L. Hedden;Ashland Licensing and Intellectual Property LLC, 5200 Blazer Parkway, Dublin, OH, 43017, US

(21) Appl. No.: 11/438,671

(22) Filed: May 22, 2006

Related U.S. Application Data
(60) Provisional application No. 60/683,610, filed on May 23, 2005.

(51) Int. Cl. C08K 3/26; C09B 67/00

(52) U.S. Cl. 524/425; 524/502

(57) ABSTRACT

This invention relates to a two-step process for rapidly repairing structures, which utilizes (a) a water-based emulsion component in the first step, and (b) a polyisocyanate-terminated pre-polymer component in the second step, such that the mixture of (a) and (b) cure in the presence of moisture.

### CLAIM TO PRIORITY

This application claims the benefit of U.S. provisional application No. 60/683,610 filed on May 23, 2005, the contents of which are hereby incorporated into this application.

### TECHNICAL FIELD

This invention relates to a two-step process for rapidly repairing structures, which utilizes (a) a water-based emulsion component in the first step, and (b) a polyisocyanate-terminated pre-polymer component in the second step, such that the mixture of (a) and (b) cure in the presence of moisture.

### BACKGROUND

The Air Force and other services have critical needs for technology for the rapid construction, repair, and safe operation of airbases. One of the problems involved in carrying out such activities is the presence of moisture in or around the structure to be repaired.

Typically, solvent-based binders, usually as two-component binders, are used in bonding aggregates. These binders are typically based on phenolic-urethane chemistry. Most commonly, such contain a large amount of solvents, usually 40 to 50 weight percent. The solvents are usually aromatic hydrocarbons, such as toluene, xylene, and others. For instance, see U.S. Pat. Nos. 6,130,268 and 5,872,203, and DE 29,920,721.

All citations referred to in this application are expressly incorporated by reference.

### BRIEF DESCRIPTION OF THE FIGURES

FIG. 1 shows the effect of the percent binder on the compressive strength of the cores made with the binder and aggregate.

FIG. 2 shows the effect of the ratio of pre-polymer to emulsion of compressive strength.

FIG. 3 shows the effect of the weight percent binder on the flexural strength.

### SUMMARY

This invention relates to a two-step process for rapidly repairing structures, which utilizes (a) a water-based emulsion component in the first step, and (b) a polyisocyanate pre-polymer component in the second step, such that the mixture of (a) and (b) cure in the presence of moisture.

The polyisocyanate-terminated pre-polymer component contains polyisocyanate pre-polymer and a divalent metal catalyst, and optionally a tertiary amine catalyst.

The process is particularly useful for rapid construction and repair, e.g. airfield damage repair applications, crater repair, pothole repair, bridge repair, road repair, and ramp repair.

The structures formed by carrying out the process have excellent water resistance, flexural strength, and compressive strength. These components used in the process cure rapidly in presence of moisture, e.g. water, atmospheric moisture. Additionally, the components used are preferably solvent-free.

The resulting binder used in the process has good shelf stability and excellent bonding strength to aggregates in presence of moisture.

The binders used in the process provide advantages over other polyurethane binders because they cure in the presence of high levels of water without a degradation of strength properties. It is known that most polyurethane systems tend to lose mechanical performance in presence of moisture.

### DETAILED DESCRIPTION

The water-based emulsions used in the process contain water and a polymer that can form an emulsion in water. The water-based emulsions also preferably contain a filler and an emulsion stabilizer.

Preferably used as the polymers in the water-based emulsion are polyvinyl alcohol and/or styrene-butadiene rubber.

The weight ratio of water to the polymer in the water water-based emulsion ranges from about 0.2 to 1.5, preferably about 0.5 to 1.2, most preferably from about 0.6 to 1.0.

Fillers that can be used in the water-based emulsion include low-density inorganic materials having a density of 0.5 g/cm³ to 1.7 g/cm³, preferably from 0.7 g/cm³ to 1.3 g/cm³, e.g. diatomaceous earth, hollow microspheres, ceramic spheres, and expanded perlite and vermiculate, and/or a higher-density filler, e.g. calcium carbonate, mica, vollastonite, talc, kaolin, carbon, silica, and alumina. Preferably used as the filler are calcium carbonate. The amount of filler used typically is from about 10 to 35 weight percent, preferably about 15 to 30 weight percent, most preferably from about 20 to 25 weight percent, where said weight percent is based upon the weight of the polymer in the water-based emulsion.

Stabilizers that can be used in the water-based emulsion include any surfactant that will stabilize the emulsion of water and polymer. These surfactants are well known to those of ordinary skill in the art, and include anionic, nonionic, cationic and amphoteric surfactants. Specific examples of such surfactants include DowFax, and Arosel. The amount of stabilizer used typically is from about 0.05 to 0.5 weight percent, preferably about 0.1 to 0.2 weight percent, most preferably from about 0.05 to 0.08 weight percent, where said weight percent is based upon the weight of the polymer in the water-based emulsion.

The pH of the water-based emulsion typically ranges from about 6 to about 8, preferably from about 6.8 to about 7.2.

The polyisocyanate pre-polymers used in the process are the reaction products of an excess of organic polyisocyanate and an active hydrogen-containing compound. Although primary and secondary amines can be used as the active hydrogen-containing compound to prepare the pre-polymer, preferably the active hydrogen-containing compound is a compound having hydroxyl group with a functionality of at least 2.0. The pre-polymers are prepared by methods well known to those of ordinary skill in the art. The amount of free isocyanate in the polyisocyanate pre-polymer typically ranges from 1 to 30, preferably from 9 to 18, and most preferably from 12 to 14 percent free NCO content.

The polyisocyanate pre-polymer is prepared by reacting the Organic polyisocyanate with typically from 1 to 50 weight percent, preferably from 35 to 48 weight percent, of a compound having active hydrogen-containing groups, preferably free hydroxyl groups, where said weight percent is based upon the weight percent of the organic polyisocyanate. Typical compounds having free hydroxyl groups include polyhydric alcohols (e.g. glycols), phenolic resole resins, polyolefin polyols, polycarbonate polyols, polyester polyols, polyether polyols, and mixtures thereof.

The general procedure for preparing the polyisocyanate pre-polymer involves heating the hydroxyl-containing compound in the presence of the organic polyisocyanate until all of the active hydrogen-containing groups have reacted in the presence of a divalent metal catalyst. Examples of divalent metal catalysts include compounds having a divalent metal ion such as zinc, lead, manganese, copper, tin, magnesium, cobalt, calcium, or barium. Specific examples include dibutyltindilaurate stannous octoate, dibutyltin diacetate, and stannous oleate. Particularly useful is dibutyltindilaurate. The divalent metal catalyst is typically added to the pre-polymer in an amount of from 0.01% to 1.0% by weight of the pre-polymer, preferably about in a range between 0.01 to 0.5%. The mixture is typically heated to a temperature of about 50° C. for about two hours.

The tertiary amine catalysts are liquid tertiary amines. Examples include 4-alkyl pyridines wherein the alkyl group has from one to four carbon atoms, isoquinoline, arylpyridines such as phenyl pyridine, pyridine, acridine, 2-methoxypyridine, pyridazine, 3-chloro pyridine, quinoline, N-methyl imidazole, N-ethyl imidazole, 4,4′-dipyridine, 4-phenylpropylpyridine, 1-methylbenzimidazole, and 1,4-thiazine. Preferably used as the liquid tertiary amine catalyst is an aliphatic tertiary amine, particularly [tris(3-dimethylamino)propylamine]. Preferably used as the tertiary amine are 2,2′-dimorpholinodiethylether and N,N′-dimethylpiperazine.

The amount of tertiary amine catalyst used is typically from 0.1 to 1.0 parts by weight, preferably from 0.01 to 0.5 parts by weight, most preferably from 0.1 to 0.25 parts by weight.

The organic polyisocyanate used to prepare the organic polyisocyanate pre-polymer is an organic polyisocyanate having a functionality of two or more, preferably 2 to 5. It may be aliphatic, cycloaliphatic, aromatic, or a hybrid polyisocyanate. Mixtures of such polyisocyanates may be used. Representative examples of organic polyisocyanates are aliphatic polyisocyanates such as hexamethylene diisocyanate, alicyclic polyisocyanates such as 4,4′-dicyclohexylmethane diisocyanate, and aromatic polyisocyanates such as 2,4-diphenylmethane diisocyanate and 2,6-toluene diisocyanate, and dimethyl derivatives thereof. Other examples of suitable organic polyisocyanates are 1,5-naphthalene diisocyanate, triphenylmethane triisocyanate, xylylene diisocyanate, and the methyl derivatives thereof, polymethylenepolyphenyl isocyanates, chlorophenylene-2,4-diisocyanate, and the like. The organic polyisocyanate is used in a liquid form. Solid or viscous polyisocyanates must be used in the form of organic solvent solutions, the solvent generally being present in a range of up to 80 percent by weight of the solution.

It may be useful in some cases to blend the pre-polymer with an organic polyisocyanate. If an organic polyisocyanate is blended with the organic polyisocyanate pre-polymer, the amount of organic polyisocyanate blended is from 1 to about 10 percent by weight, based upon the weight of the organic polyisocyanate pre-polymer.

Typical compounds having free hydroxyl groups include polyhydric alcohols (e.g. glycols), phenolic resole resins, polyolefin polyols, polycarbonate polyols, polyester polyols, polyether polyols, and mixtures thereof.

Polyhydric alcohols include ethylene glycol, propylene glycol, diethylene glycol, 1,4-butanediol, neopentyl glycol, 1,6-hexanediol, cyclohexane dimethanol, glycerol, trimethylolpropane, and pentaerythritol.

The polyether polyols are liquid polyether polyols generally having hydroxyl numbers from about 200 to about 1,000, more preferably from 300 to 800, and most preferably from 300 to 600 milligrams of KOH based upon one gram of polyether polyol. The viscosity of,the polyether polyol is from 100 to 1,000 centipoise, preferably from 200 to 700 centipoise, most preferably 300 to 500 centipoise. The hydroxyl groups of the polyether polyols are preferably primary and/or secondary hydroxyl groups.

The polyether polyols are prepared,by reacting an alkylene oxide with a polyhydric alcohol in the presence of an appropriate catalyst such as sodium methoxide according to methods well known in the art. Representative examples of alkylene oxide include ethylene oxide, propylene oxide, butylene oxide, amylene oxide, styrene oxide, or mixture thereof. The polyhydric alcohols typically used to prepare the polyether polyols generally have a functionality greater than 2.0, preferably from 2.5 to 5.0, most preferably from 2.5 to 4.5. Examples include ethylene glycol, diethylene glycol, propylene glycol, trimethylol propane, glycerin, and pentaerythritol.

Preferably used as the hydroxyl-containing compound to prepare the polyisocyanate pre-polymers are liquid polyester polyols having a hydroxyl number from about 500 to 2,000, preferably from 700 to 1200, and most preferably from 250 to 600; a functionality equal to or greater than 2.0, preferably from 2 to 4; and a viscosity of 500 to 50,000 centipoise at 25° C., preferably 1,000 to 35,000, and most preferably 2,000 to 25,000 centipoise. They are typically prepared by ester interchange of an ester and alcohols or glycols by an acidic catalyst. The amount of the aromatic polyester polyol in the polyol component is from 2 to 50 weight percent, preferably from 10 to 35 weight percent, most preferably from 10 to 25 weight percent based upon the polyol component.

Preferably used as the polyester polyol are aromatic polyester polyols. These are prepared by the ester interchange of an aromatic polyester such as phthalic anhydride based polyester and polyethylene terephthalate with a polyhydric alcohol such as ethylene glycol, diethylene glycol, triethylene glycol, 1,3, propane diol, 1,4 butane diol, dipropylene glycol, tripropylene glycol, tetraethylene glycol, glycerin, and mixtures thereof. Examples of commercial available aromatic polyester polyols are Lexorez 1102-60, Lexorez-1640-150, Lexorez Resins manufactured by Inolex Corp.

Phenolic resins, which can be used as the polyol, include phenolic resole resins, preferably polybenzylic ether phenolic resins. The phenolic resole resin is prepared by reacting an excess of aldehyde with a phenol in the presence of either an alkaline catalyst or a divalent metal catalyst according to methods well known in the art. Solvents, as specified, are also used in the phenolic resin component along with various optional ingredients. The polybenzylic ether phenolic resin is prepared by reacting an excess of aldehyde with a phenol in the presence of a divalent metal catalyst according to methods well known in the art. They preferably contain a preponderance of bridges joining the phenolic nuclei of the polymer which are ortho-ortho benzylic ether bridges. They are prepared by reacting an aldehyde and a phenol in a mole ratio of aldehyde to phenol of at least 1:1, generally from 1.1:1.0 to 3.0:1.0 and preferably from 1.1:1.0 to 2.0:1.0, in the presence of a metal ion catalyst, preferably a divalent metal ion such as zinc, lead, manganese, copper, tin, magnesium, cobalt, calcium, or barium.

In some applications, it may be useful to add an inhibitor to retard the curing rate of the binder, which improves the storage stability of the pre-polymer. Typical inhibitors include benzoyl chloride, benzenephosphorus oxydichloride, phosphorus oxychloride, phthaloyl chloride, and monophenyldichlorophosphate.

Conventional defoamers, such as D-1400 (from Dow Corning), may also be added to the binder to promote homogeneous mix and faster reaction during the preparation of binder.

Any aggregate can be used in connection with the binder. The aggregate may be an aggregate shipped to the site where the space is to be filled or some indigenous material found at the site. Examples of aggregate include sand, zircon, alumina-silicate sand, chromite sand, fly ash, pea gravel, grit, particles of stone, sandstone, clay, crushed concrete, etc. The aggregate is typically used in amounts of 5 to 95 weight percent based upon the total weight of the binder and aggregate.

The process is most simply carried out by adding the water-based emulsion to the space to be filled. The space to be filled and/or the water-soluble emulsion may also contain aggregate. Then the second component is added to the space to be filled in an amount to sufficiently fill the space and make it useful for its normal purpose. The aggregate itself may or may not contain water.

The weight ratio of (a) to (b) typically ranges from 1 to 9, preferably from 1 to 6, most preferably from 1 to 4.

The total amount of (a) plus (b) can vary over wide ranges depending upon the specific application. Typically amount ranges from about 5 parts by weight to about 50 parts by weight, preferably from about 10 parts by weight to about 30 parts by weight, where said parts by weight are based upon the parts by weight of the aggregate if an aggregate is used.

Abbreviations

ISOSET® UX 100 a polyisocyanate pre-polymer, sold commercially by Ashland Specialty Chemical Company, a division of Ashland Inc., having a free NCO content of about 15 to 20 weight percent prepared by reacting a polyether polyol with MDI.

ISOSET® A322 water-based emulsion, sold by Ashland Inc., comprising about 20 weight percent of calcium carbonate suspended in a solution comprising about 50 weight percent water, about 10 to 15 weight percent of a polyvinyl alcohol, and about 10 to 15 weight percent of a styrene-butadiene rubber.

### EXAMPLES

The following examples will illustrate some specific ways to carry out this invention. These examples are merely illustrative and not intended to be exhaustive of all embodiments within the scope of the claims. In the examples, all units are in the metric system and all amounts and percentages are by weight, unless otherwise expressly indicated.

### Example 1

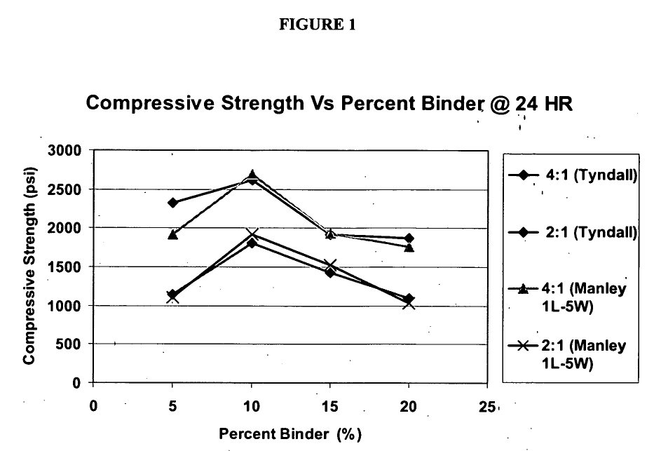

ISOSET® A322 was added to Manley IL-5W sand and to Tyndall sand (a silica sand obtained from Florida in the vicinity of the United States Tyndall Air Force Base and characterized as having AFS GFN 57.93, pH of 6.4, and a moisture content ranging from 1 to 2 weight percent. Then ISOSET® UX100 was added to the sand at different levels (5, 10 15, 20 weight percent). The percentages are the total weight percentages based on UX100 and A322 (hereinafter referred to as the “binder”). The weight ratio of UX100 to A322 is shown in FIG. 1. The moisture content of the Manley IL-5W sand was 0.02 weight percent and the moisture content of the Tyndall sand was 1.4 weight percent. The Tyndall sand was pre-dried at 100° C. for 24 hours to remove the moisture prior to using.

The water (1.0 weight percent) was added to the dry Manley 1L-5W sand, and pre-dried Tyndall sand and mixed for 1 minute and then the binder was added to the wet sand and mixing continued for another 2 minutes. The resulting mixture was added to a 1 inch height by 1 inch diameter tube, which had a silicone release liner. After 24 hours, the specimen was removed from the tube and compressive strength was determined. Compressive strength was determined using the test method described in ASTM C579-96. The test method covers compressive strength of chemical resistant mortars, grouts, monolithic surfacings, and polymer concrete.

Compressive strengths were determined within 24 hours for the various levels of binder.

FIG. 1 shows the compressive strength for the 10 and 20 weight percent binder as 2685 psi and 1866 psi, respectively at 24 hours at 4:1 weight ratio of pre-polymer to emulsion. The data indicate that the compressive strength increased with increasing amount of binder up to about 10 weight percent binder, but decreased at higher levels of binder, as depicted in FIG. 1, which is probably a result of the binder reaching its optimum strength at 1.0 weight percent water content and 10 weight percent binder. In addition, the compressive strength was higher at a 4:1 ratio of UX 100 to A 322 than a ratio of 2:1.

### Example 2

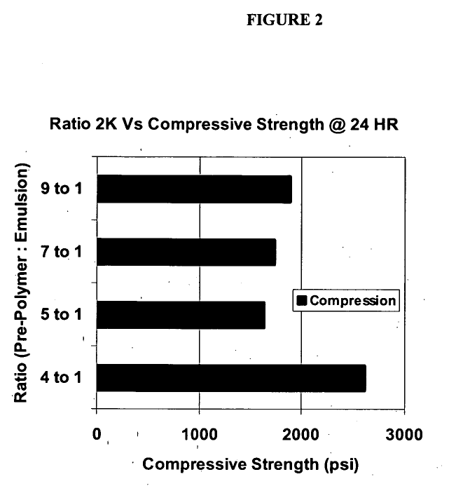

Example 1 was repeated using Tyndall sand and 10 weight percent binder, except different ratios of binder component to water-based emulsion were used, namely ratios of 5:1, 7:1 and 9:1 of binder component to emulsion. The compressive strengths were then measured at 24 hours and plotted graphically as indicated in FIG. 2. The data in FIG. 2 indicates that compressive strength increased with increasing binder component on both sands. They further suggest that the 4:1 ratio of pre-polymer to aqueous emulsion provides the best results.

The data in Examples 1 and 2 indicate that the compressive strength increases with increasing level of binder of up to about 10 weight per cent at a constant concentration of water on both aggregates. The data indicate that both systems cure in presence of moisture and produce structures with adequate strengths rapidly. This is unusual because most polyurethane binder systems traditionally lose their mechanical strength in presence of moisture.

### Example 3

Example 2 was repeated, except flexural strength was measured after 24 hours using the preferred ratio of pre-polymer to water-based emulsion (4:1) at increasing amounts of binder.

The water was added to the sand and mixed for 1 minute and then the binder was added to the wet sand and mixing was continued for another 2 minutes. The resulting mixture was added to a 1×1×10 inch aluminum mold. After 24 hours, the 1×1×10 inch bar was removed from the mold and flexural strength was determined. Flexural strength was determined using the test method described in ASTM C580-93. The test method covers the determination of flexural strength and modulus of elasticity in flexure of cured chemical-resistant materials in the form of molded rectangular beams. These materials include mortars, brick and tile grouts, structural grouts, machinery grouts, monolithic surfacings, and polymer concrete.

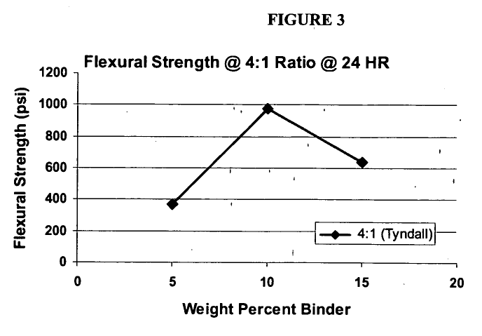

The results are set forth graphically in FIG. 3, which shows an increase in flexural strength as the amount of binder was increased up to 10 weight percent, but decreases at higher levels of binder.

As with compressive strength measurements, flexural strength decreases with increasing moisture. At some point, increasing the binder level does not show additional improvement, which is evidently because all of the free isocyanate has completely reacted with the moisture.

We claim:

1. A two-step process for filling a space comprising:
(a) adding a water-based emulsion component to said space,
(b) then adding a polyisocyanate pre-polymer component to said space, wherein said polyisocyanate pre-polymer component comprises a polyisocyanate pre-polymer containing free isocyanate groups
wherein the amount of (a) added to said space is such that (a) contains sufficient water to cure (b).

2. The process of claim 1 wherein said pre-polymer is the reaction product of a polyol and a polyisocyanate.

3. The process of claim 2 wherein the content of free isocyanate groups in said pre-polymer is from 10 to 18 percent.

4. The process of claim 3 wherein the polyol is selected from the group consisting of polyester polyols, polyether polyols, phenolic resole resins, and mixtures thereof.

5. The process of claim 4 wherein said water-based emulsion comprises water, a polymer, an inorganic filler, and a pH stabilizer.

6. The process of claim 5 wherein the amount the inorganic filler is calcium carbonate and the polymer is selected from the group consisting of polyvinyl alcohol, styrene butylene rubber, and mixtures thereof.

7. The process of claim 6 wherein the pH of the water-based emulsion is from about 6.0 to about 7.0.

8. The process of claim 7 wherein the amount of water in the water-based emulsion is from about 10 parts by weight to about 50 parts by weight, the amount of filler in the water-soluble emulsion is from about 10 parts by weight to about 20 parts by weight, and the amount of stabilizer in the water-soluble emulsion is from about 10 parts by weight to about 15 parts by weight.

9. The process of claim 7 wherein the weight ratio of water-based emulsion component to polyisocyanate pre-polymer component is from about 1:4 to about 4:1 and the binder is used in amount of 10 weight percent or less.

10. The process of claim 10 wherein said water-based emulsion further comprises an aggregate.

11. The process of claim 9 wherein said space to be filled contains an aggregate.

12. The process of claim 1, 2, 3, 4, 5, 6, 7, 8, 9, 10, or 11, 12, or 13 wherein the polyisocyanate pre-polymer component also contains a catalytically effective amount of a tertiary amine catalyst.

13. The process of 12 wherein the tertiary amine catalyst is selected from the group consisting of tertiary amine are 2,2′-dimorpholinodiethylether and N,N′-dimethylpiperazine.

14. The process of claim 12 wherein the amount of divalent metal catalyst is from about 0.5 parts by weight to about 1.5 parts by weight based upon the weight of the polyisocyanate pre-polymer.

15. The process of claim 14 wherein the amount of aggregate is from 50 parts by weight to about 95 parts by weight based upon 100 parts by weight of said polyisocyanate pre-polymer.

16. The process of claim 15 wherein space to be filled is an opening in an airport runway.

17. The process of claim 11 wherein the aggregate is selected from the group consisting of sand, crushed concrete, pea gravel, and rock.
